(19) United States
(12) Patent Application Publication
(10) Pub. No.: US 2019/0331964 A1
(43) Pub. Date: Oct. 31, 2019

(54) BACKLIGHT SURFACE LIGHT SOURCE AND LIQUID CRYSTAL DISPLAY DEVICE

(71) Applicant: WUHAN CHINA STAR OPTOELECTRONICS TECHNOLOGY CO., LTD., Wuhan City (CN)

(72) Inventor: Shiyuan Xiao, Wuhan City (CN)

(21) Appl. No.: 16/098,439

(22) PCT Filed: Sep. 22, 2018
(86) PCT No.: PCT/CN2018/107141

§ 371 Date: Nov. 2, 2018

(30) Foreign Application Priority Data
Apr. 25, 2018 (CN) 201810380782.4

(51) Int. Cl. G02F 1/1335; G09G 3/32; G09G 3/36

(52) U.S. Cl. CPC G02F 1/133603; G09G 3/36; G09G 3/32

(57) ABSTRACT

Provided are a backlight surface light source and a liquid crystal display device. The backlight surface light source includes a mini light emitting diode substrate and a plurality of mini light emitting diodes disposed on the mini light emitting diode substrate, and the mini light emitting diode has a micrometer size, which can greatly reduce a thickness of the backlight surface light source; the mini light emitting diode substrate is provided with a through hole, and the mini light emitting diodes are disposed on the mini light emitting diode substrate evenly around the through hole. The mini light emitting diodes can be decreased to reduce the production cost, and meanwhile, the uniform illumination of the backlight surface light source can be ensured. The backlight surface light source has a thin thickness and can uniformly emit light, which is favorable for a thin design of the liquid crystal display device.

### FIELD OF THE INVENTION

The present invention relates to a display field, and more particularly to a backlight surface light source and a liquid crystal display device.

### BACKGROUND OF THE INVENTION

With the development of display technology, the flat panel device, such as Liquid Crystal Display (LCD) possesses advantages of high image quality, power saving, thin body and wide application scope. Thus, it has been widely applied in various consumer electrical products, such as mobile phone, television, personal digital assistant, digital camera, notebook, laptop, and becomes the major display device. Most of the liquid crystal displays on the present market are back light type liquid crystal displays, which comprise a liquid crystal display panel and a back light module. The working principle of the liquid crystal display panel is to locate liquid crystal molecules between two parallel glass substrates, and a plurality of vertical and horizontal tiny electrical wires are between the two glass substrates. The light of back light module is reflected to generate images by applying driving voltages to control whether the liquid crystal molecules to be changed directions. Because the liquid crystal display panel itself does not emit light and needs the back light module to provide light source for normally showing images. Therefore, the backlight module is the key component of the liquid crystal display device. According to the different light source incident positions, the backlight module can be categorized into two kinds, the side light type backlight module and a direct light type backlight module.

In the prior art, referring to FIG. 1, there is a liquid crystal display device including a liquid crystal panel 100 and a backlight module 200. The liquid crystal panel 100 is provided with a first through hole 120, and the backlight module 200 is provided with a second through hole 240 corresponding to the position of the first through hole 120. As shown in FIG. 2, as the backlight module 200 is a side light type backlight module, the light guide plate 220 of the backlight module 200 includes a third through hole 242 corresponding to the first through hole 120. A dark area 280 is easily generated in the vicinity of the third through hole 242, and the light emitted by the LED 260 cannot reach the dark area 280, thereby the viewing comfort of the user will be affected. In order to solve the above problems, a conventional direct light type backlight module is generally used. As shown in FIG. 3, the direct light type backlight module 300 includes a LED substrate 310, a plurality of LEDs 360 disposed on the LED substrate 310 and an optical film 330 disposed on the plurality of LEDs 360. The optical film 330 includes a fourth through hole 334 corresponding to the first through hole 120, and the LED substrate 310 includes a fifth through hole 340 corresponding to the first through hole 120 and the fourth through hole 334. The optical film 330 is used to uniformly diffuse the light emitted by the plurality of LEDs 360 to form a surface light source. Therefore, the conventional direct light type backlight module has a larger thickness, and the thin shape of the irregular screen liquid crystal display device cannot be realized.

The mini light emitting diode (Mini LED) display device is a display device that integrates a micrometer size LED array on a substrate as display pixels to realize an image display, and each pixel can be addressed and individually driven to illuminate, which belongs to a self-illuminating display. The power consumption is small, and the color saturation is close to OLED. Many manufacturers regard it as the current research point.

### SUMMARY OF THE INVENTION

An objective of the present invention is to provide a backlight surface light source, which can uniformly emit light and is favorable for a thin design of the liquid crystal display device to enhance the differentiated performance of the product and to improve the market competitiveness of the product.

An objective of the present invention is to provide a liquid crystal display panel, which can uniformly emit light and is favorable for a thin design of the liquid crystal display device to enhance the differentiated performance of the product and to improve the market competitiveness of the product.

For realizing the aforesaid objectives, the present invention provides a backlight surface light source for a liquid crystal panel, comprising a mini light emitting diode substrate and a plurality of mini light emitting diodes disposed on the mini light emitting diode substrate.

The mini light emitting diode substrate is provided with a through hole to cooperate with the liquid crystal panel.

The through hole is completely or partially surrounded by the mini light emitting diodes.

The plurality of mini light emitting diodes is disposed on the mini light emitting diode substrate evenly around the through hole.

The through hole is circular, elliptical or polygonal.

The present invention further provides a liquid crystal display device, comprising a liquid crystal panel and a backlight surface light source disposed on one side of the liquid crystal panel;

wherein the backlight surface light source comprises a mini light emitting diode substrate and a plurality of mini light emitting diodes disposed on the mini light emitting diode substrate, and the mini light emitting diodes are disposed toward the liquid crystal panel.

The liquid crystal panel is provided with a via hole penetrating through the liquid crystal panel, and the mini light emitting diode substrate of the backlight surface light source is provided with a through hole aligned with the via hole.

The through hole is completely or partially surrounded by the mini light emitting diodes.

The plurality of mini light emitting diodes is disposed on the mini light emitting diode substrate evenly around the through hole.

The via hole is a same shape as the through hole, and is circular, elliptical or polygonal.

The beneficial results of the present invention are: provided is a backlight surface light source, including a mini light emitting diode substrate and a plurality of mini light emitting diodes disposed on the mini light emitting diode substrate, and the mini light emitting diode has a micrometer size, which can greatly reduce a thickness of the backlight surface light source; the mini light emitting diode substrate is provided with a through hole, and the mini light emitting diodes are disposed on the mini light emitting diode substrate evenly around the through hole. The mini light emitting diodes can be decreased to reduce the production cost, and meanwhile, the uniform illumination of the backlight surface light source can be ensured. The backlight surface light source provided by the present invention has a thin thickness and can uniformly emit light, which is favorable for a thin design of the liquid crystal display device to enhance the differentiated performance of the product and to improve the market competitiveness of the product.

### BRIEF DESCRIPTION OF THE DRAWINGS

In order to better understand the characteristics and technical aspect of the invention, please refer to the following detailed description and accompanying drawings of the present invention. However, the drawings are provided for reference only and are not intended to be limiting of the invention.

In drawings,

FIG. 1 is a schematic structural diagram of an irregular screen liquid crystal display device according to the prior art;

FIG. 2 is a top view diagram of a light guide plate of a side light type backlight module of an irregular screen liquid crystal display device according to the prior art;

FIG. 3 is a schematic structural diagram of an irregular screen liquid crystal display device using a direct light type backlight module according to the prior art;

FIG. 4 is a schematic structural diagram of a liquid crystal display device according to the present invention;

FIG. 5 is a schematic diagram of a liquid crystal display device according to the present invention;

FIG. 6 is a schematic diagram of a liquid crystal panel of a liquid crystal display device according to the present invention;

FIG. 7 is a schematic diagram of a backlight surface light source of a liquid crystal display device according to the present invention.

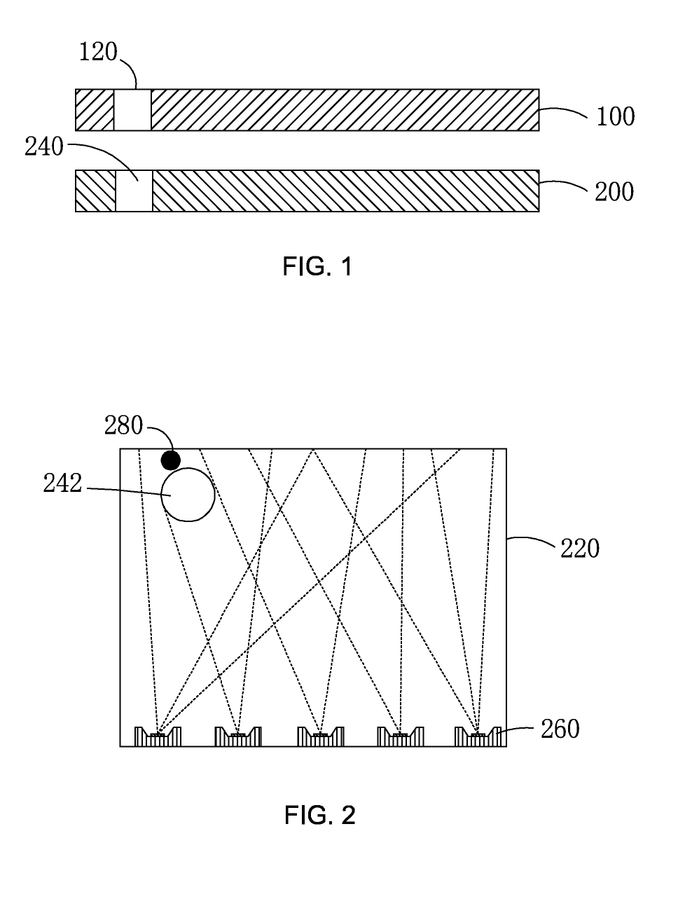

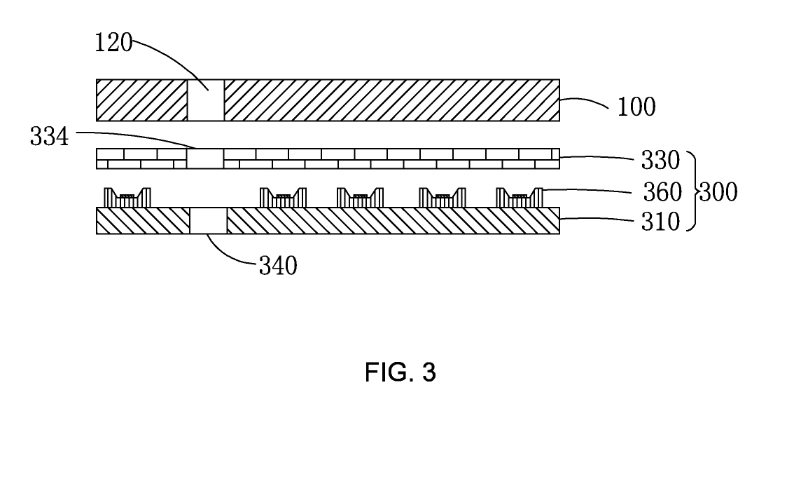

### DETAILED DESCRIPTION OF PREFERRED EMBODIMENTS

For better explaining the technical solution and the effect of the present invention, the present invention will be further described in detail with the accompanying drawings and the specific embodiments.

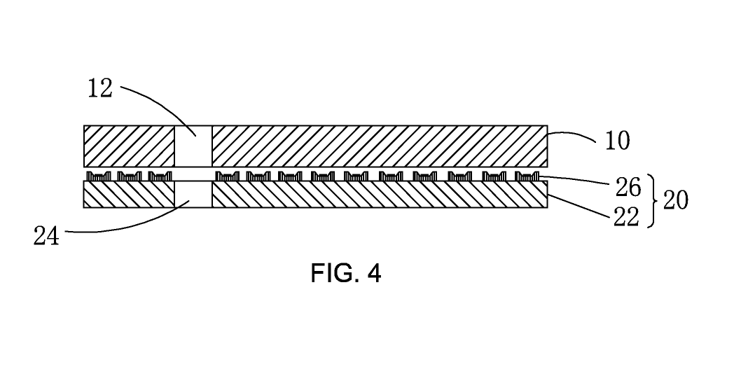

Please refer to FIG. 4. The present invention provides backlight surface light source 20 for a liquid crystal panel 10, comprising a mini light emitting diode (Mini LED) substrate 22 and a plurality of mini light emitting diodes 26 disposed on the mini light emitting diode substrate 22. Compared with the prior art using LEDs as a light source, the present invention uses Mini LEDs of a micrometer size as a surface light source. The thickness of the Mini LED itself can be greatly reduced, and the optical film sheet can be further omitted to reduce the overall thickness. As the backlight surface light source 20 is applied to a liquid crystal display device, it is advantageous for a thin design of the liquid crystal display device.

Specifically, as shown in FIG. 4 and FIG. 7, the liquid crystal panel 10 is a irregular screen liquid crystal panel, and the irregular screen liquid crystal panel is provided with a through hole 12. The mini light emitting diode substrate 22 is provided with a through hole 24 to cooperate with the liquid crystal panel 10.

Specifically, the through hole 24 is completely or partially surrounded by the mini light emitting diodes 26.

Specifically, the plurality of mini light emitting diodes 26 is disposed on the mini light emitting diode substrate 22 evenly around the through hole 24. The setting amount of the mini light emitting diodes 26 can be decreased to reduce the production cost, and meanwhile, the uniform illumination of the backlight surface light source 20 can be ensured.

Specifically, the through hole 24 may be circular or elliptical. Certainly, the through hole 24 may also be polygonal, such as triangular, square or rectangular according to actual product requirements.

The foregoing backlight surface light source 20 includes a mini light emitting diode substrate 22 and a plurality of mini light emitting diodes 26 disposed on the mini light emitting diode substrate 22, and the mini light emitting diode 26 has a micrometer size, which can greatly reduce a thickness of the backlight surface light source 20; the mini light emitting diode substrate 22 is provided with a through hole 24, and the mini light emitting diodes 26 are disposed on the mini light emitting diode substrate 22 evenly around the through hole 24. The amount of the mini light emitting diodes 26 can be decreased to reduce the production cost, and meanwhile, the uniform illumination of the backlight surface light source 20 can be ensured.

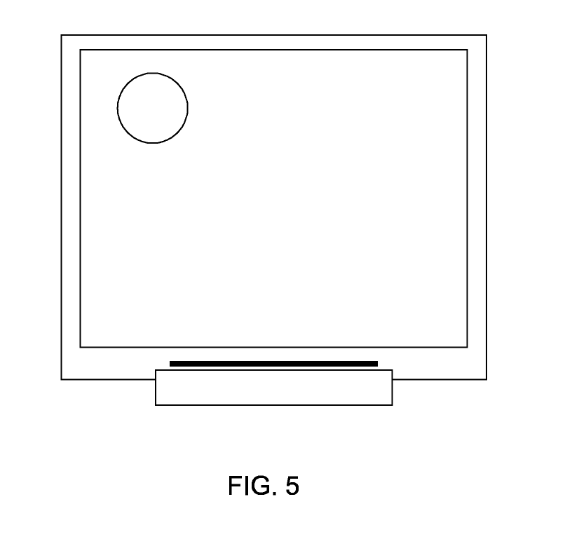

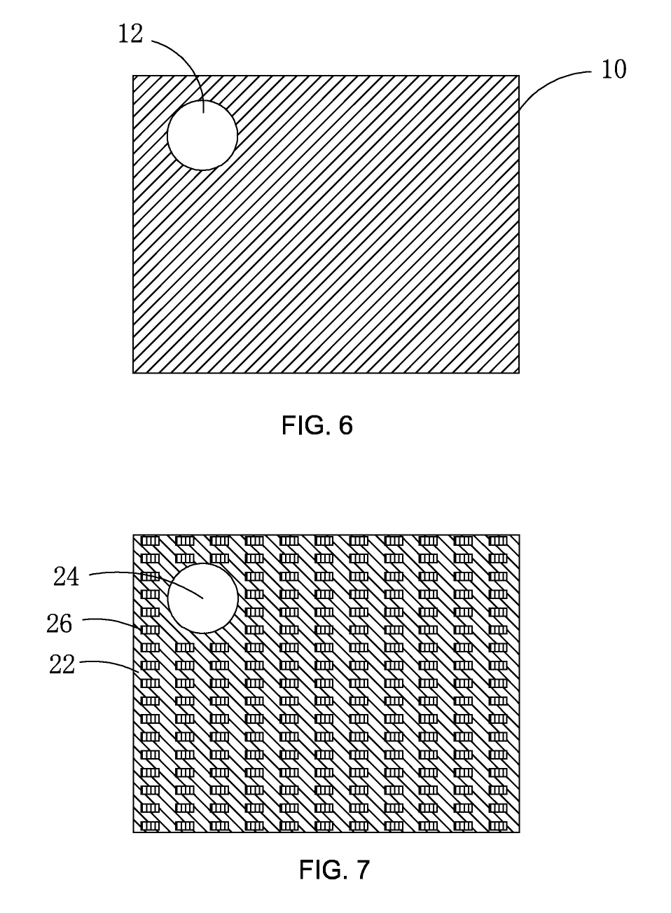

On the basis of the aforesaid backlight surface light source 20, referring to FIGS. 4 to 7, the present invention further provides a liquid crystal display device, comprising a liquid crystal panel 10 and a backlight surface light source 20 disposed on one side of the liquid crystal panel 10;

wherein the backlight surface light source 20 comprises a mini light emitting diode substrate 22 and a plurality of mini light emitting diodes 26 disposed on the mini light emitting diode substrate 22, and the mini light emitting diodes 26 are disposed toward the liquid crystal panel 10. Compared with the prior art using LEDs as a light source, the present invention uses Mini LEDs of a micrometer size as a surface light source. The thickness of the Mini LED itself can be greatly reduced, and the optical film sheet can be further omitted to reduce the overall thickness. As the backlight surface light source 20 is applied to a liquid crystal display device, it is advantageous for a thin design of the liquid crystal display device.

Specifically, the liquid crystal panel 10 is provided with a via hole 12 penetrating through the liquid crystal panel 10, and the mini light emitting diode substrate 22 of the backlight surface light source 20 is provided with a through hole 24 aligned with the via hole 12.

Specifically, the through hole 24 is completely or partially surrounded by the mini light emitting diodes 26.

Specifically, the plurality of mini light emitting diodes 26 is disposed on the mini light emitting diode substrate 22 evenly around the through hole 24. The setting amount of the mini light emitting diodes 26 can be decreased to reduce the production cost, and meanwhile, the uniform illumination of the backlight surface light source 20 can be ensured.

Specifically, the liquid crystal panel 10 is provided with the through hole 12 penetrating the liquid crystal panel 10. Therefore, the area of the liquid crystal panel 10 corresponding to the through hole 12 is not required to be displayed. In the present invention, the mini light emitting diode substrate 22 of the backlight surface light source 20 is provided with the through hole 24 corresponding to the via hole 12 of the liquid crystal panel 10. The plurality of mini light emitting diodes 26 are disposed on the mini light emitting diode substrate 22 around the through hole 24, so that the area of the liquid crystal panel 10 corresponding to the via hole 12 does not show light.

The via hole 12 is a same shape as the through hole 24. Furthermore, the via hole 12 and the through hole 24 may be circular or elliptical. Certainly, the via hole 12 and the through hole 24 may also be polygonal, such as triangular, square or rectangular according to actual product requirements.

Specifically, the Mini LED 26 is a white light Mini LED or a blue light Mini LED.

The backlight surface light source 20 of the foregoing liquid crystal display device includes a mini light emitting diode substrate 22 and a plurality of mini light emitting diodes 26 disposed on the mini light emitting diode substrate 22, and the mini light emitting diode 26 has a micrometer size, which can greatly reduce a thickness of the backlight surface light source 20 and is beneficial for the thin design of the liquid crystal display device; the mini light emitting diode substrate 22 is provided with a through hole 24, and the mini light emitting diodes 26 are disposed on the mini light emitting diode substrate 22 evenly around the through hole 24. The amount of the mini light emitting diodes 26 can be decreased to reduce the production cost, and meanwhile, the uniform illumination of the backlight surface light source 20 can be ensured.

In conclusion, the backlight surface light source includes a mini light emitting diode substrate and a plurality of mini light emitting diodes disposed on the mini light emitting diode substrate, and the mini light emitting diode has a micrometer size, which can greatly reduce a thickness of the backlight surface light source; the mini light emitting diode substrate is provided with a through hole, and the mini light emitting diodes are disposed on the mini light emitting diode substrate evenly around the through hole. The mini light emitting diodes can be decreased to reduce the production cost, and meanwhile, the uniform illumination of the backlight surface light source can be ensured. The backlight surface light source has a thin thickness and can uniformly emit light, which is favorable for a thin design of the liquid crystal display device to enhance the differentiated performance of the product and to improve the market competitiveness of the product.

Above are only specific embodiments of the present invention, the scope of the present invention is not limited to this, and to any persons who are skilled in the art, change or replacement which is easily derived should be covered by the protected scope of the invention. Thus, the protected scope of the invention should go by the subject claims.

What is claimed is:

1. A backlight surface light source for a liquid crystal panel, comprising a mini light emitting diode substrate and a plurality of mini light emitting diodes disposed on the mini light emitting diode substrate.

2. The backlight surface light source according to claim 1, wherein the mini light emitting diode substrate is provided with a through hole to cooperate with the liquid crystal panel.

3. The backlight surface light source according to claim 2, wherein the through hole is completely or partially surrounded by the mini light emitting diodes.

4. The backlight surface light source according to claim 2, wherein the plurality of mini light emitting diodes is disposed on the mini light emitting diode substrate evenly around the through hole.

5. The backlight surface light source according to claim 2, wherein the through hole is circular, elliptical or polygonal.

6. A liquid crystal display device, comprising a liquid crystal panel and a backlight surface light source disposed on one side of the liquid crystal panel;
wherein the backlight surface light source comprises a mini light emitting diode substrate and a plurality of mini light emitting diodes disposed on the mini light emitting diode substrate, and the mini light emitting diodes are disposed toward the liquid crystal panel.

7. The liquid crystal display device according to claim 6, wherein the liquid crystal panel is provided with a via hole penetrating through the liquid crystal panel, and the mini light emitting diode substrate of the backlight surface light source is provided with a through hole aligned with the via hole.

8. The liquid crystal display device according to claim 7, wherein the through hole is completely or partially surrounded by the mini light emitting diodes.

9. The liquid crystal display device according to claim 7, wherein the plurality of mini light emitting diodes is disposed on the mini light emitting diode substrate evenly around the through hole.

10. The liquid crystal display device according to claim 7, wherein the via hole is a same shape as the through hole, and is circular, elliptical or polygonal.
